(19) United States
(12) Patent Application Publication
(10) Pub. No.: US 2007/0113722 A1
(43) Pub. Date: May 24, 2007

(54) Adjustable drum pedal assembly

(76) Inventor: Kuo-Chang Chen, Taichung Hsien (TW)

Correspondence Address: THE MAXHAM FIRM, 9330 SCRANTON ROAD, SUITE 350, SAN DIEGO, CA, 92121, US

(21) Appl. No.: 11/339,909

(22) Filed: Jan. 25, 2006

(30) Foreign Application Priority Data
Nov. 21, 2005 (TW) 094220139

(51) Int. Cl. G10D 13/02

(52) U.S. Cl. 84/422.1

(57) ABSTRACT

An adjustable drum pedal assembly has a rotated shaft, a drive device and a chain. The rotated shaft has a fixed bracket formed on the rotated shaft and has a screwed hole. The drive device is mounted on the rotated shaft and has a base, a combining element, a bolt and a fastener. The base is combined with the fixed bracket and has a side groove, a bottom groove and multiple adjusting holes. The side groove is formed in the base and the bottom groove is communicated with the side groove. The adjusting holes are formed in the top of the base. The combining element is mounted on the base and has a through groove. The bolt is screwed into the screwed hole and the fastener is screwed into one of the adjusting holes. The chain is mounted between the drive device and the drum pedal.

### BACKGROUND OF THE INVENTION

1. Field of the Invention

The present invention relates to a drum pedal assembly, and more particularly to an adjustable drum pedal assembly for adjusting positions of the pedal conveniently and rapidly.

2. Description of Related Art

With reference to FIGS. 5 and 6, a drum pedal assembly (50) generally comprising a bottom board (51), two posts (52), a drum pedal (53), a rotated shaft (60), a drive device (70) and a chain (80).

The bottom board (51) has a distal end and a proximal end, and the posts (52) are mounted on and extend upward from the bottom board (51) near the distal end and face to each other. Each post (52) has a distal end, a proximal end and a connecting hole. The proximal end of the post (52) is mounted on the bottom board (51), and the connecting hole is defined through the distal end of the post (52). The drum pedal (53) is pivotally connected to the bottom board (51) and has a pivotal end and an action end. The pivotal end of the drum pedal (53) is connected to the bottom board (51) by a pivotal pin.

The rotated shaft (60) is connected rotatably between the posts (52) and has two ends, a connected bracket (61) and a drum hammer (62). The ends of the rotated shaft (60) are respectively mounted into the connecting holes of the posts (52). The connected bracket (61) is mounted on the rotated shaft (60) and has a distal end, a proximal end and a through hole. The through hole is defined near the proximal end of the connected bracket (61) and has a noncircular cross section. The rotated shaft (60) has a noncircular cross section corresponding to that of the through hole in the connecting bracket (61) and extends through the through hole to make the connecting bracket (61) to rotate with the rotated shaft (60). The drum hammer (62) is attached to the connected bracket (61) near the distal end.

The drive device (70) is mounted on the rotated shaft (60) and has a top, a bottom, two sides, a securing hole (701), a fastener (71), a side through hole (702), a bottom hole and a bolt (73). The securing hole (701) is formed in the top of the drive device (70) and the fastener (71) is screwed into the securing hole (701). The side through hole (702) through which the rotated shaft (60) extends is formed through the drive device (70) between the two sides and has a noncircular cross section corresponding to that of the rotated shaft (60). The bottom hole is formed in the bottom of the drive device (70) and communicates with the side through hole (702). The bolt (73) is mounted into the bottom hole and contacts with the rotated shaft (60), such that the drive device (70) is rotated with the rotated shaft (60).

The chain (80) is connected between the drum pedal (53) and the drive device (70) and has a proximal end, a distal end and a connecting plate (81). The distal end of the chain (80) is connected to the action end of the drum pedal (53). The connecting plate (81) is mounted on the proximal end of the chain (80) and has a through hole (810). The fastener (71) extends through the through hole (810) in the connecting plate (81) and is screwed into the securing hole (701) in the drive device (70) to connect the proximal end of the chain (80) to the drive device (70).

When a user treads on the drum pedal (53), the chain (80) will pull the drive device (70) and the rotated shaft (60) to rotate so as to make the drum hammer (62) to swing to hit a drum.

However, the drum pedal assembly (50) only has a securing hole (701), so the position of the chain (80) connected to the drive device (70) is not adjustable such that the conventional drum pedal assembly (50) is not versatile in use.

### SUMMARY OF THE INVENTION

The main objective of the present invention is to provide a drum pedal assembly that is adjustable and versatile in use.

An adjustable drum pedal assembly has a rotated shaft, a drive device and a chain. The rotated shaft has a fixed bracket formed on the rotated shaft and has a screwed hole. The drive device is mounted with the rotated shaft and has a base, a combining element, a bolt and a fastener. The base is combined with the fixed bracket and has a side groove, a bottom groove and multiple adjusting holes. The side groove is formed in the base and the bottom groove is communicated with the side groove. The adjusting holes are formed in the top of the base. The combining element is mounted on the base and has a through groove. The bolt is screwed into the screwed hole and the fastener is screwed into one of the adjusting holes. The chain is mounted between the drive device and the drum pedal.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an adjustable drum pedal assembly in accordance with the present invention;

FIG. 2 is a side view in partial section of the adjustable drum pedal assembly in FIG. 1;

FIG. 3 is an operational side view in partial section of the adjustable drum pedal assembly in FIG. 1;

FIG. 4 is an operational side view in partial section of the adjustable drum pedal assembly in FIG. 1 showing that;

FIG. 5 is a perspective view of a conventional drum pedal assembly in accordance with the prior art; and

FIG. 6 is a partially exploded perspective view of the conventional drum pedal assembly in FIG. 5.

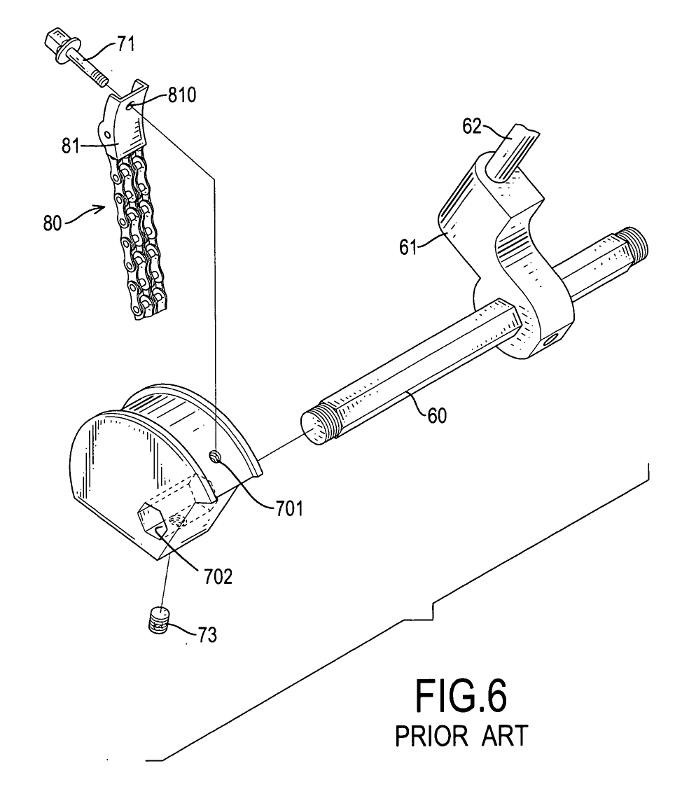

### DETAILED DESCRIPTION OF THE PREFERRED EMBODIMENT

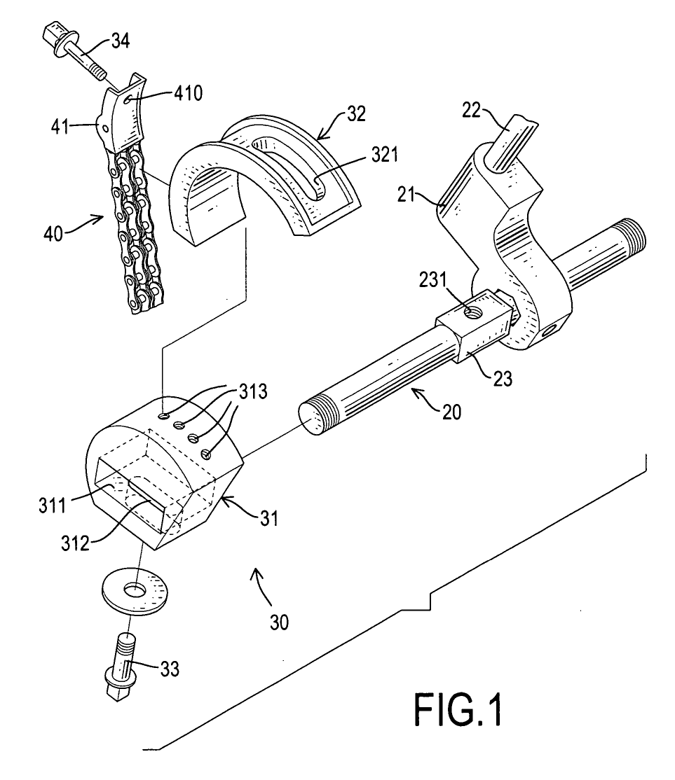

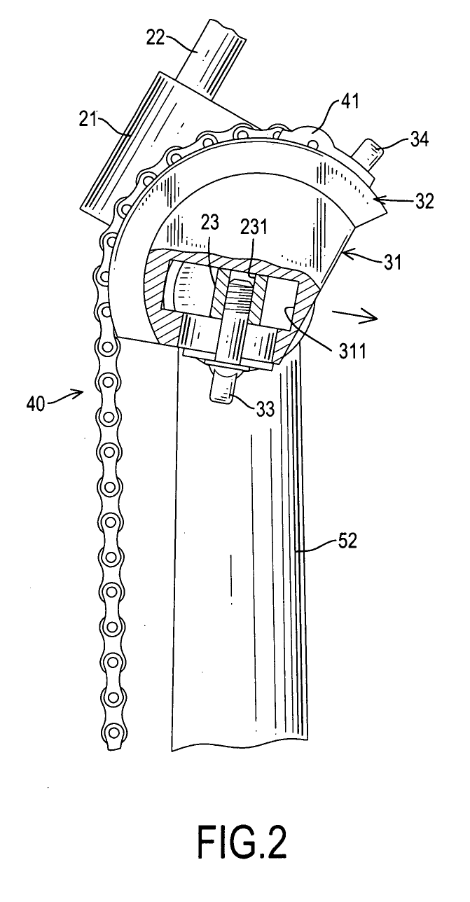

With reference to FIGS. 1, 2, 3 and 5, an adjustable drum pedal assembly (10) in accordance with the present invention comprises a bottom board (51), two posts (52), a drum pedal (53), a rotated shaft (20), a drive device (30) and a chain (40).

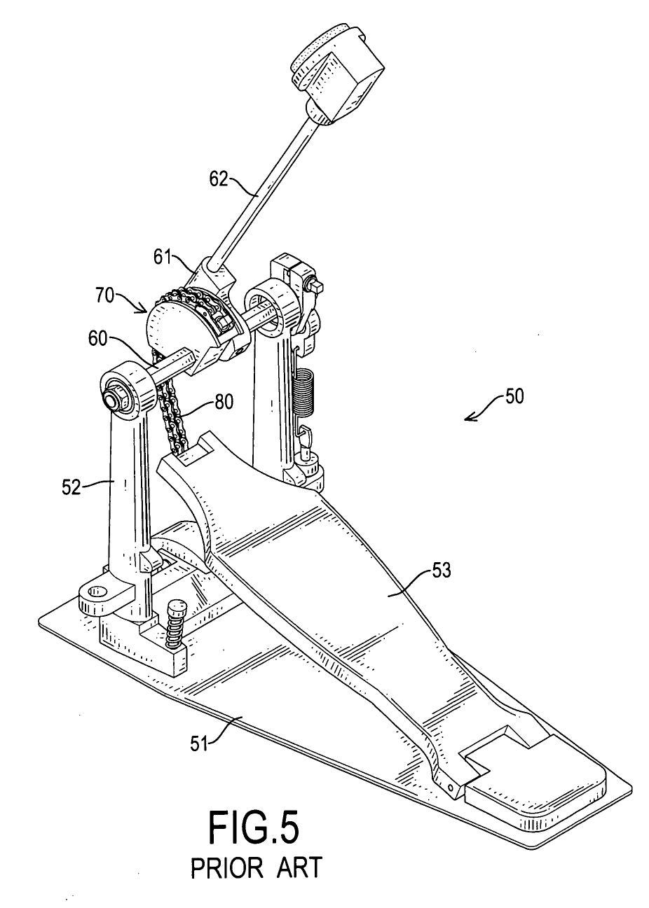

The bottom board (51), two posts (52) and the drum pedal (53) may have structures same as that of the conventional drum pedal assembly (50) as shown in FIG. 5 and do not be further described.

The rotated shaft (20) is connected rotatably between the posts (52) and has two ends, a connecting bracket (21), a drum hammer (22) and a fixed bracket (23). The ends of the rotated shaft (20) are respectively mounted in the connecting holes of the posts (52). The connecting bracket (21) is mounted on the rotated shaft (20) and has a distal end, a proximal end and a through hole. The through hole is formed near the proximal end of the connected bracket (21) and is mounted around the rotated shaft (20). The drum hammer (22) is attached to the connected bracket (21) near the distal end. The fixed bracket (23) is formed on the rotated shaft (20) and has a top, a bottom and a screwed hole (231). The screwed hole (231) is defined through the fixed bracket (23) from the top to the bottom of the fixed bracket (23).

The drive device (30) is mounted on the fixed bracket (23) on rotated shaft (20) and has a base (31), a combining element (32), a bolt (33) and a fastener (34). The base (31) is combined with the fixed bracket (23) and has a top, a bottom, two sides, a side groove (311), a bottom groove (312) and multiple adjusting holes (313). The side groove (311) is defined through the sides of the base (31), and the fixed bracket (23) is held inside and engages with the side groove (311). The bottom groove (312) is a long shaped and formed in the bottom of the base (31) and communicates with the side groove (311). The adjustable holes (313) are formed linearly in the top of the base (31). The combining element (32) is curved, is mounted around the top of the base (31) and has a top, a bottom and a through groove (321). The through groove (321) is defined through the combining element (32) from the top to the bottom. The bolt (33) extends through the bottom groove (312) and is screwed into the screwed hole (231) in the fixed bracket (23) and the base (31) can be adjusted the location between the rotated shaft (20) by the bolt extending through the bottom groove (312). Furthermore, the fastener (34) extends through the through groove (321) in the combining element (32) and is screwed into one of the adjusting holes (313) in the base (31) to combine the combining element (32) onto the base (31).

The chain (40) is mounted between the drive device (30) and the action end of the drum pedal (53), and has a proximal end, a distal end and a connecting plate (41). The distal end of the chain (40) is connected to the action end of the drum pedal (53). The connecting plate (41) is mounted on the proximal end of the chain (40) and has a through hole (410). The fastener (34) extends through the through hole (410) in the connecting plate (41) and the through groove (321) in the combining element (32) and is screwed into one of the adjusting holes (313) in the base (31) to connect the proximal end of the chain (40) to the drive device (30).

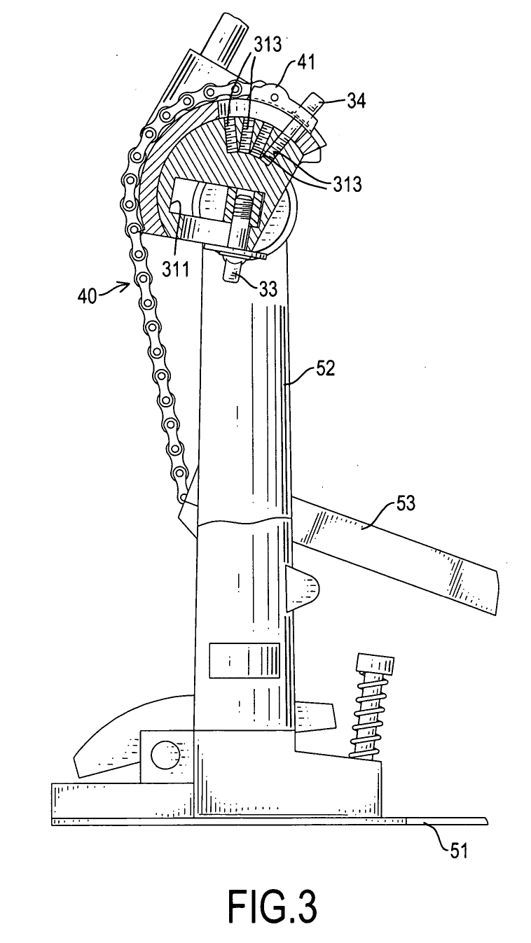

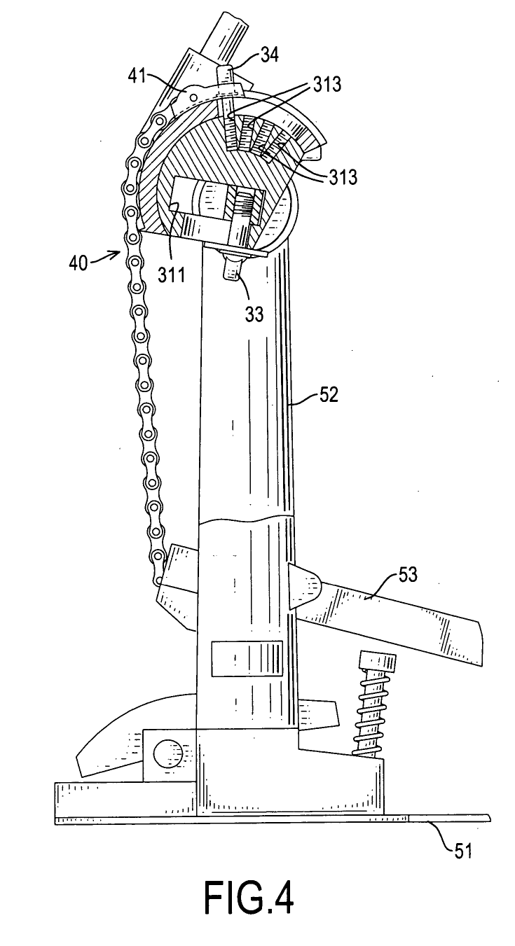

With reference to FIGS. 3 and 4, after loosening the fastener (34) from the corresponding adjusting hole (313), the fastener (34) can be slide along the through groove (321) and aligns with and is screwed into another adjusting hole (313). Consequently, the combining position of the chain (40) and the base (31) of drive device (30) will be changed, such that the distance between the bottom board (51) and the drum pedal (53) is adjusted.

The adjustable drum pedal assembly (10) as described has the following advantages:

1. The drum pedal assembly (10) has multiple adjusting holes (313) in the drive device (30), and position of the chain (40) connected to the drive device (30) can be changed. Thus, the height of the drum pedal (53) relative to the bottom board (51) can be adjusted based on the user's needs.

2. The fastener (34) and the bolt (33) can firmly combine the base (31), the combining element (32) and the drive shaft (20) together to provide a stability structure of the drum pedal assembly (10).

Even though numerous characteristics and advantages of the present utility model have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adjustable drum pedal assembly having
a bottom board having
a distal end; and
a proximal end;
two posts mounted on the bottom board near the distal end, facing to each other and each having
a distal end;
a proximal end mounted on the bottom board; and
a connecting hole defined through the distal end of the post;
a drum pedal pivotally connected to the bottom board and having
a pivotal end connected to the bottom board; and
an action end;
a rotated shaft connected rotatably between the posts and having
two ends respectively mounted in the connecting holes of the posts;
a connecting bracket mounted on the rotated shaft and having
a distal end;
a proximal end; and
a through hole formed through the proximal end of the connected bracket and mounted around the rotated shaft;
a drum hammer attached to the connecting bracket near the distal end of the connecting bracket; and
a fixed bracket formed on the rotated shaft and having
a top;
a bottom; and
a screwed hole defined through the fixed bracket from the top to the bottom of the fixed bracket;
a drive device mounted on the fixed bracket on the rotated shaft and having
a base mounted around and combined with the fixed bracket and having
a top;
a bottom;
two sides;
a side groove defined through the sides of the base to hold and the engage with the fixed bracket;
a bottom groove formed in the bottom of the base and communicating with the side groove; and
multiple adjustable holes formed linearly in the top of the base;
a combining element being curved, mounted around the top of the base and having
a top;
a bottom; and
a through groove defined through the combining element from the top to the bottom of the combined element;
a bolt extending through the bottom groove in the base and screwed into the screwed hole in the fixed bracket; and
a fastener extending through the through groove and screwed into one of the adjusting holes in the base; and
a chain connected between the drive device and the drum pedal and having
a proximal end;
a distal end connected to the action end of the drum pedal; and
a connecting plate mounted on the proximal end of the chain and having
a through hole; and
wherein the fastener extends through the through hole in the connecting plate and the through groove in the combining element and is screwed into one of the adjusting holes in the base to connect the proximal end of the chain to the drive device.

2. The adjustable drum pedal assembly as claimed in claim 1, wherein the bottom groove is a long shaped and the base can be adjusted the location between the rotated shaft by the bolt extending through the bottom groove.
